(19) United States
(12) Patent Application Publication
(10) Pub. No.: US 2013/0270852 A1
(43) Pub. Date: Oct. 17, 2013

(54) Apparatus and Method for Facilitating the Lifting of Heavy Objects

(71) Applicant: Michael E. Adams, Oak Lawn, IL (US)

(72) Inventor: Michael E. Adams, Oak Lawn, IL (US)

(21) Appl. No.: 13/861,548

(22) Filed: Apr. 12, 2013

Related U.S. Application Data
(60) Provisional application No. 61/686,808, filed on Apr. 12, 2012.

(51) Int. Cl. B65G 7/12

(52) U.S. Cl. CPC B65G 7/12
USPC 294/167

(57) ABSTRACT

A supplemental handle device that involves both sides of the body in the act of carrying buckets of heavy loads. The device comprises a Hitching Bar, and a Grab Loop with a hand grip and a ring connecting the Bar and Loop. The Hitching Bar comprises: a front eyelet for attaching the ring; a middle aperture for sliding the Bar over the bucket handle; and a rear U-shaped element underneath the bucket handle and with the bail fitted snuggly between the two arms of the “U”. The Grab Loop is for the user's hand on the opposing side of the bucket. In use, the Hitching Bar's middle aperture passes over the bucket handle, and slides forward until the U-shaped element lies beneath the handle, locking the bail. By simultaneously pulling up on the Hitching Bar-handle unit with one hand, and the Grab Loop with the other, the bucket is raised.

### RELATED APPLICATIONS

The application claims priority from U.S. Provisional Application 61/686,808 entitled “SUPPLEMENTAL HANDLE DEVICE FOR FIVE GALLON BUCKETS”, filed Apr. 12, 2012, and herein incorporated by reference.

### FIELD OF THE INVENTION

The present invention is generally related to supplemental handle devices such as “panel carriers” for sheets of plywood or drywall, and so-called “hump straps” used by commercial movers to help carry furniture and bedding, and more particularly related to a new type supplemental handle device which easily, and efficiently, allows both sides of a user's body to assist in the lifting and carrying of common five gallon buckets filled with paint, sheetrock compound, roofing tar, floor wax, and the like.

### BACKGROUND OF THE INVENTION

The “five gallon” bucket, whether from molded plastic or rolled sheet steel, has long been the standard container for a very wide range of consumer, commercial, and industrial goods. Paints, waxes, solvents, epoxies, mastics, food products, particulates and more are stored and then transported every day in this ultimate commodity product. Indeed, the uninterrupted demand for the five gallon bucket is so high that hundreds of millions of new units are produced annually.

For all their utility, however, the sheer weight of these full buckets—exceeding 100 lbs. at the heaviest—means that moving them any distance at all by hand is difficult for even strong individuals, and a real challenge strength and endurance wise for those of just average, much less low strength. Adding to the difficulty is the fact that because all the weight is carried by just one hand on one side of the body, these loads are inherently cumbersome and “lop-sided”, adding to the challenge of carrying them about.

Although none is currently known to exist, there would thus appear to be a need for a device that allows previously unused muscles and structures on the non-bucket side of the user's body to assist in the lifting and carrying of five gallon plastic or steel buckets. The device would reduce overall “effort” on the bucket side of the user's body, and lessen, or completely eliminate, various twisting and other strains currently experienced by both sides of the user's body when carrying full five gallon buckets. Such a device should be lightweight, compact, easy to use and durable, yet inexpensive to produce so as to be affordably priced for the homeowner, handyman, and trade professional. The present invention satisfies all these requirements.

### SUMMARY OF THE INVENTION

The present invention comprises an apparatus that attaches to a carrier device (e.g. a bucket with a handle on the bail) that is used in carrying heavy loads, such as paint, mortar, and the like, for the purpose of distributing the load over the user's body to reduce muscular-skeletal stress and strain and prevent injury. The carrier device comprises a chamber encasing a load of material; and, a hand grip attached by yoke, frame or bail to the chamber. The hand grip comprises: a handle that is about the size of a user's closed palm, is generally tubular in shape; and, a suspension member that is thinner than the handle's width. The handle encases the suspension member that extends from both ends of the handle and attaches to the chamber. The apparatus comprises two members wherein the first member contacts the underside of the carrier device's hand grip while tightly securing the suspension member within the first member when the device is lifted. The apparatus's first member is thus not dislodged from the carrier device's handle when the full weight of the device is borne by the apparatus.

The apparatus comprises two members: a Hitching Bar first member, and a Grab Loop second member. The Hitching Bar member comprises: a front eyelet element for the ring; a middle aperture element larger in diameter than the standard bucket handle (e.g. plastic hand grip); and a rear U-shaped element with a central slot just slightly wider than the standard bucket bail (e.g. see FIG. 8).

The Grab Loop member comprises a hand grasp means for the user's opposing hand (i.e. hand that supplements lifting of carrier device), such as a loop or strap of webbing having a hand grip, and a means of connecting the Hitching Bar member to the Grab Loop, such as a metal ring or clasp or closed hook. In one embodiment of a loop of webbing and a metal ring, the webbing is sewn to the ring, and forms the “Grab Loop” for the user's hand on the opposing side of a bucket (e.g. see FIGS. 4-7).

In use, the Hitching Bar's middle aperture passes over the carrier device's handle (e.g. bucket handle), and is slid forward until the U-shaped element rests beneath the handle. By simultaneously pulling up on the Hitching Bar-handle unit with one hand, and the Grab Loop grip with the other, the carrier device (e.g. bucket) is raised.

The present invention is designed to easily attach to, or uncouple from, the wire “bail”-bucket handle assemblies widely found on five gallon buckets of the type used to store and transport paint, asphalt sealant, mortar, and the like.

The principal object of the invention is to provide a way that the heavy, cumbersome, and inherently “one-sided” weight of full five gallon buckets can be borne by muscles and structures on both sides of a user's body.

An additional object of the present invention is to provide the shortest, most direct connection between the muscles and structures on the “non-bucket” side of a user's body, and the weight of a five gallon bucket.

A still further object of the present invention is to provide an apparatus that satisfies the above requirements in an easily deployed, easily stored device that is durable, inexpensive to make, and highly efficient. The invention shown in the figures and explained below achieves these objectives.

### BRIEF DESCRIPTION OF THE DRAWINGS

The apparatus and methods of use that embody the above and other inventive features will now be described with reference to the following drawings.

FIG. 1 is an overhead view of the Hitching Bar.

FIG. 2 is an underside view of the Hitching Bar illustrating the beveled, rear, U-shaped support element.

FIG. 3 is a perspective view of the underside of the Hitching Bar further illustrating the beveled, rear, U-shaped support element.

FIG. 4 is a front view of the Grab Loop comprising the connecting ring and the grip.

FIG. 5 is an illustration of the two main components: the Hitching Bar (left) and the Grab Loop (right), separated.

FIG. 6 is an illustration of the two main components joined with the “D” type connecting ring of the Grab Loop hooked through the eyelet of the Hitching Bar.

FIG. 7 is an illustration of the method of using the apparatus by the user lifting up on the carrier device (e.g. bucket) with the attached Hitching Bar while simultaneously pulling diagonally up on the Grab Loop with the opposing hand.

FIG. 8 is a diagram showing the actual dimensions and structure of one embodiment of the Hitching Bar.

### DETAILED DESCRIPTION

The present invention comprises an apparatus that connects to the handle of a carrier device that is used in lifting and transporting loads of material, such as five gallon buckets with bails (the semicircular wire and hand grip carrying handle of the bucket). The device is especially suitable for use with heavy loads, such as a bucket with bail and a handle encircling the bail. The bucket may be filled with especially heavy loads, such as paint, sheetrock compound, roofing tar, floor wax, and the like. The description infra is for one embodiment for use of the apparatus with a five gallon bucket, but the apparatus is appropriate for use with other carrier devices comprising pull-up handle grips connected to loops of thin material or wire from which the carrier encasing the load suspends (e.g. bags, satchels, luggage, etc.). It is understood that the artisan could readily alter the exemplified embodiment infra to suit the use of the apparatus to other types of carrier devices without engaging in undue experimentation.

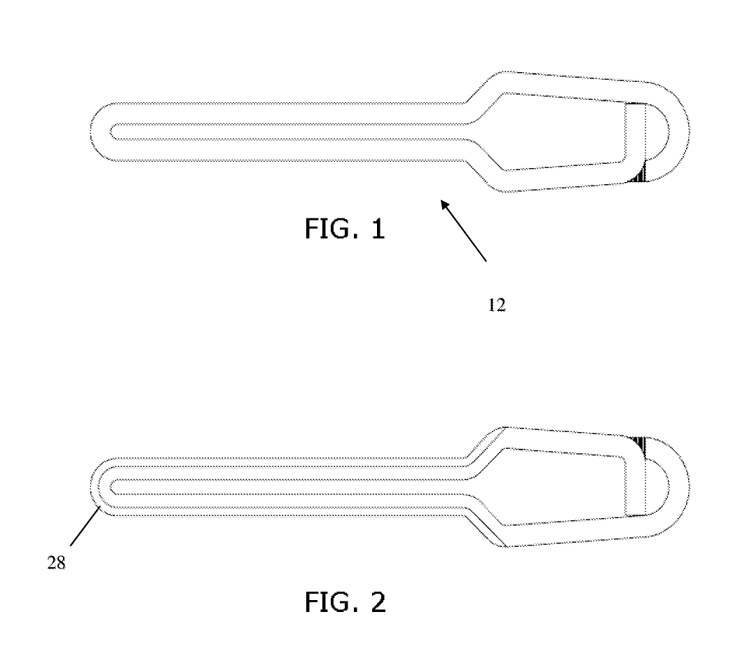

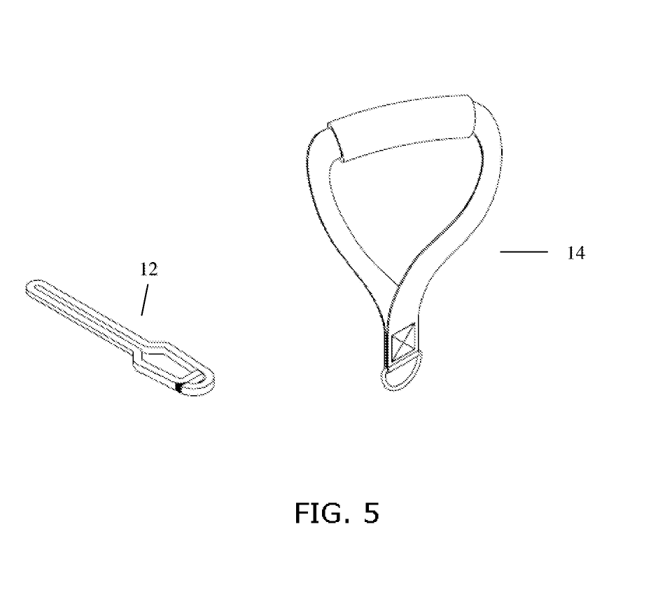

One embodiment of the present invention, as illustrated in FIGS. 1-8, is directed to a simple apparatus 10 comprising two main components: 1) a Hitching Bar 12; and, 2) a Grab Loop 14. The Grab Loop subsequently comprises an attached connecting means 20, such as a closed ring, clasp, closed hook, and the like, and an attached grip 30.

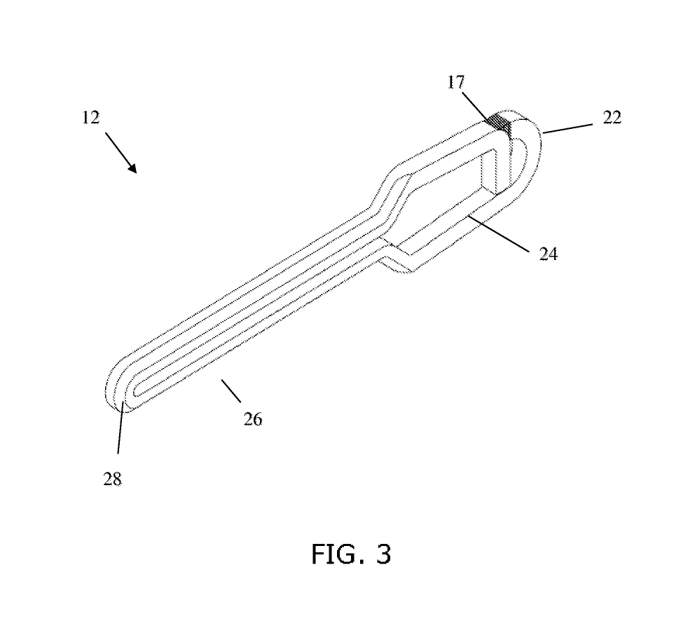

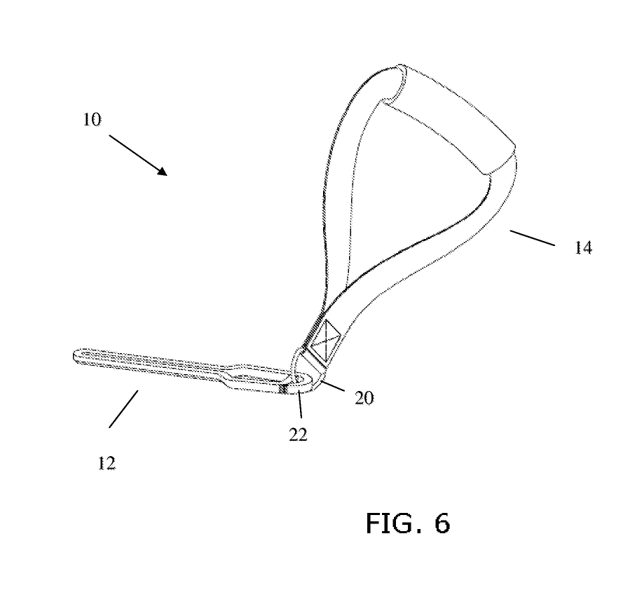

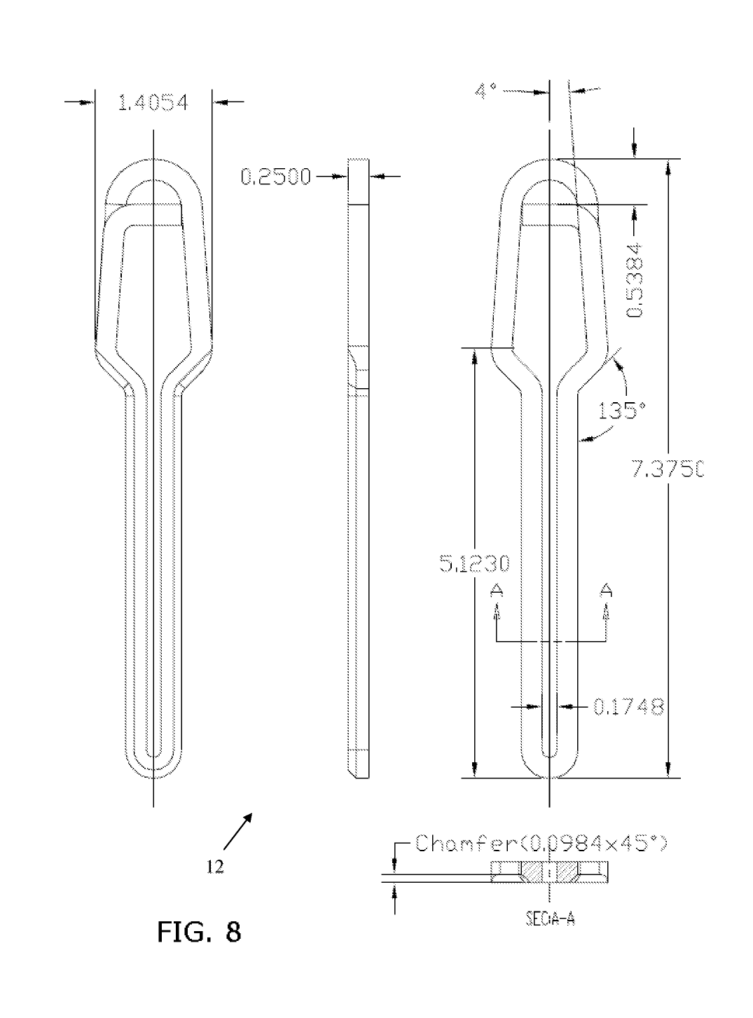

In one embodiment illustrated in FIG. 8, the Hitching Bar 12 is a wire form made from square steel rod approximately 0.25 inches on a side, and is comprised of a front eyelet 22, a middle aperture 24, a rear U-shaped support element 26, and a beveled underside 28. It measures approximately 7.375 inches long by 1.4 inches wide, and includes a single weld 17 that closes off eyelet 22 (see FIG. 3). Eyelet 22 is the attachment point for the connecting ring 20 (see FIG. 6). It is also understood that round steel rod or wire could be used in place of the square steel rod.

The beveled underside 28 is provided for improved comfort of the user's hand when using the apparatus. Instead of the user's hand gripping apparatus 10 and making contact with a sharp edge on the underside of the apparatus, the user's hand lies against a flat surface as illustrated in (see FIGS. 2 & 3, 28). The entire outside edge of the long U-shaped slot is beveled (“chamfered”) on the underside only. This avoids the otherwise unacceptable hand discomfort from the square wire.

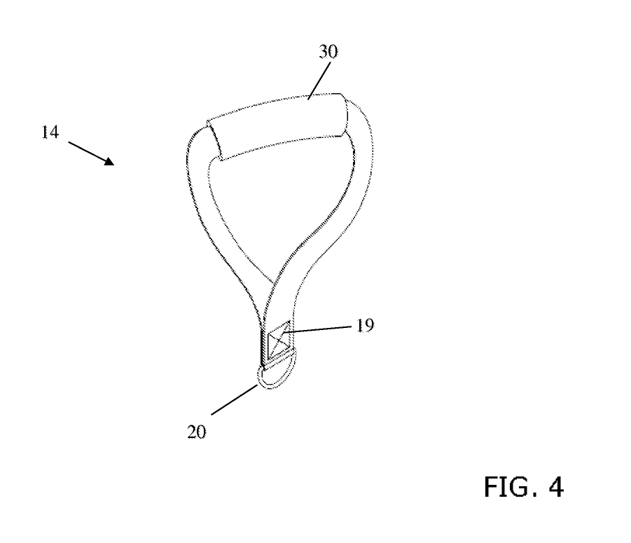

As shown in FIGS. 4-7, Grab Loop 14 is made from synthetic webbing approximately one inch wide by 0.100 inches thick, and forms an essentially upside down triangle approximately 4.375 inches wide at the base 16 by 6.75 inches tall.

The connecting ring 20 is attached to the Grab Loop 14 by sewn “box stitch” 19. In one embodiment, connecting ring 20 is a “D” type, wire form ring, made of round steel wire approximately 0.160″ in diameter, and measuring approximately 1.50 inches wide by 0.938 inches tall. It is noted, though, that other shapes of connecting ring 20 besides a “D” type are envisioned within the present invention (e.g. square, round, etc.). Grip 30 is a cut length of plastic tubing, approximately 0.800 inches high by 1.125 inches wide by 4.375 inches long.

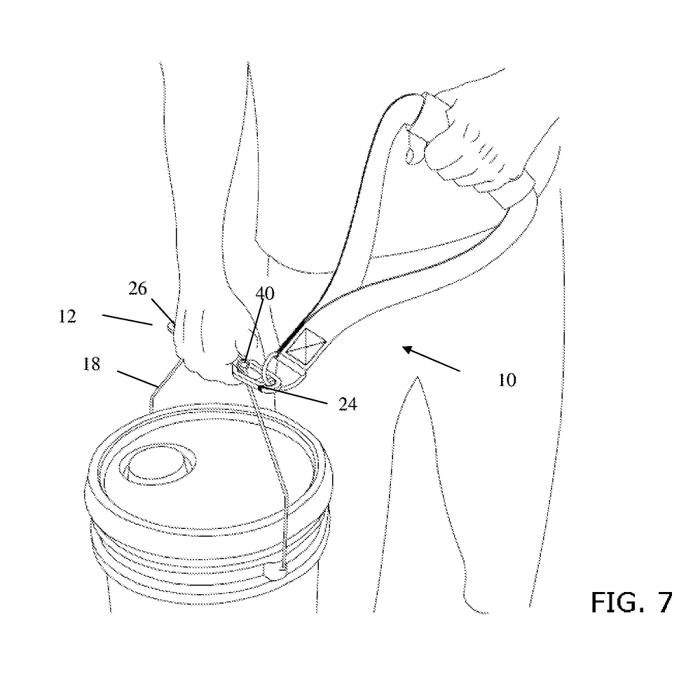

The method of use of the apparatus 10 is illustrated in FIG. 7 and comprises the following steps. While holding the apparatus loosely by eyelet 22 with the non-bucket side hand, the user swings the wire handle “bail” 18 up to its full height. With Hitching Bar 12 positioned behind the bucket handle 40, and angled slightly up, the aperture 24 is passed over the length of the bucket handle (like threading a needle), and slides forward until the closed end of U-shaped support element 26 contacts the wire bail to position the parallel rails (aka legs) of the support element completely beneath the handle 40. The user then grasps the Hitching Bar-bucket handle unit with the bucket side hand, the Grab Loop grip with the non-bucket side hand, stands erect, pulls up with the bucket side hand, and diagonally up with the non-bucket side hand, and raises the bucket.

When the connecting ring pulls up against the eyelet, the closed end of the support element presses against the wire bail to translate the diagonally upward effort of the non-bucket side of the body into substantially upward effort against the bucket's weight. The user can assume a much more erect, correct posture, his gait is more normal, and he is effectively using muscles and structures on both sides of the body to lift and carry the five gallon bucket.

As will be readily apparent to anyone skilled in the art, there are a variety of alternatives to the specific design illustrated here that still embody the basic teachings of the invention.

In one embodiment, the Grab Loop of the present invention could function alone without a “grip” component, and still connect the non-bucket side of the body to the weight of the bucket.

In another embodiment, the connecting ring and webbing used to make the Grab Loop could both be replaced by a loop formed of twisted poly or “steel rope” attached directly to the Hitching Bar eyelet.

In yet another embodiment, a bent metal wire frame is imagined that could be hooked to the eyelet at one end, and screwed, riveted or otherwise fastened to a handle at the other end.

The possible variations on the basic teachings of the present invention are in fact quite numerous. Since all these alternative designs still teach the idea of connecting the non-bucket side of a user's body, through that body side hand, to the weight of a five gallon bucket, however, they are understood to clearly fall within the teachings of the present invention.

What is claimed is:

1. An apparatus to supplement a carrier device by evenly distributing the weight of the carrier device over the user's body, wherein the carrier device comprises:
a. a chamber encasing a load of material; and,
b. a hand grip attached by yoke, frame or bail to the chamber, the grip comprising,
i. a tubular handle about the size of a user's closed palm, wherein the apparatus contacts the underside of the handle when the device is lifted; and,
ii. a suspension member that is thinner than the tubular handle's width and is tightly secured within the apparatus when the device is lifted.

2. The apparatus of claim 1 further comprising,
a. a first member attached beneath the carrier device's hand grip; and,
b. a second member attached to the first member;
c. wherein the user lifts the carrier device by the carrier device's hand grip and the first member with one hand on one side of the user's body, and simultaneously pulls diagonally up on the second member with the user's second hand on the opposing side of the user's body.

3. The apparatus of claim 2, wherein the carrier device is a five gallon bucket.

4. The apparatus of claim 3 wherein the first member is a solid horizontal member comprising:
a. a front eyelet element comprising an opening to attach the second member to the first member;
b. a middle aperture element for sliding the first member over the carrier device's hand grip; and,
c. a rear U-shaped support element for securing the first member to the carrier device's hand grip by locking the suspension member between the two parallel rails of the U-shaped element.

5. The apparatus of claim 2 wherein the second member comprises,
a. a connecting ring element that attaches to the front eyelet element; and,
b. a hand grip element pulled diagonally up with the user's second hand and attached to the connecting ring.

6. The apparatus of claim 5, wherein the front eyelet opening is created by a single weld separating the eyelet from the middle aperture to prevent the connecting ring element from contacting the middle aperture and/or the rear U-shaped element.

7. The apparatus of claim 5, wherein the connecting ring element is a D-type ring comprising round steel wire.

8. The apparatus of claim 4, wherein the first member comprises square steel rod, and the rear U-shaped support element comprises a beveled underside for the user's comfort.

9. The apparatus of claim 4, wherein the first member is approximately: 0.25 inches thick, 7.4 inches long, 1.4 inches wide at the middle aperture, and further comprises an opening in the rear U-shaped support element 0.17 inches wide.

10. A method of use of the apparatus of claim 1 comprising the steps:
a. lowering the middle aperture element of the first member over the carrier device's hand grip;
b. sliding the rear U-shaped support element of the first member beneath the handle of the carrier device's hand grip;
c. grabbing the first member and carrier device's hand grip in one hand, and the second member in the opposing hand; and,
d. lifting the first member and carrier device's hand grip in the one hand while simultaneously pulling diagonally upward on the second member with the opposing hand.

11. An apparatus to facilitate the lifting of buckets by evenly distributing the load on both sides of a user's body, the apparatus comprising,
a. a first member attached to a bucket's hand grip; and,
b. a second member attached to the first member;
c. wherein the user lifts the bucket by the bucket's hand grip and the first member with one hand on one side of the user's body, and simultaneously pulls diagonally up on the second member with the user's second hand on the opposing side of the user's body.

12. The apparatus of claim 11 wherein the first member is a solid horizontal member comprising:
a. a front eyelet element comprising an opening to attach the second member to the first member;
b. a middle aperture element for sliding the first member over the bucket's hand grip; and,
c. a rear U-shaped support element with a central slot just slightly wider than the standard bucket bail for securing the first member to the bucket's hand grip by locking the bucket's bail between the two parallel rails of the U-shaped element.

13. The apparatus of claim 12 wherein the second member comprises,
a. a connecting ring element that attaches to the front eyelet element; and,
b. a hand grip element pulled diagonally up with the user's second hand and attached to the connecting ring.

14. The apparatus of claim 13, wherein the front eyelet element's opening is created by a single weld separating the eyelet from the middle aperture to prevent the connecting ring element from contacting the middle aperture and/or rear U-shaped element.

15. The apparatus of claim 13, wherein the connecting ring element is a D-type ring comprising round steel wire.

16. The apparatus of claim 12, wherein the first member comprises square steel rod, and the rear U-shaped support element comprises a beveled underside for the user's comfort.

17. The apparatus of claim 12, wherein the first member is approximately: 0.25 inches thick, 7.4 inches long, 1.4 inches wide at the middle aperture, and further comprises an opening in the rear U-shaped support element 0.17 inches wide.

18. A method of facilitating the lifting of five gallon buckets by evenly distributing the load on both sides of a user's body by utilizing an apparatus comprising:
a. a first member attached to the bucket's hand grip; and,
b. a second member attached to the first member;
c. wherein the user lifts the bucket by the bucket's hand grip and first member with one hand on one side of the user's body, and simultaneously pulls diagonally up on the second member with the user's second hand on the opposing side of the user's body.

19. The method of claim 18 wherein, the first member is a solid horizontal member comprising:
a. a front eyelet element comprising an opening to attach the second member to the first member;
b. a middle aperture element for sliding the first member over the bucket's hand grip; and,
c. a rear U-shaped support element with a central slot just slightly wider than the standard bucket bail for securing the first member to the bucket's hand grip by locking the bucket bail between the two parallel rails of the U-shaped element;
and, wherein the second member comprises,
d. a connecting ring element that attaches to the front eyelet element; and,
e. a hand grip element pulled diagonally up with the user's second hand and attached to the connecting ring.

20. The method of claim 19 wherein,
a. the front eyelet opening is created by a single weld separating the eyelet element from the middle aperture element to prevent the connecting ring element from contacting the middle aperture and/or rear U-shaped element;
b. the connecting ring element is a D-type ring comprising round steel wire; and,
c. the rear U-shaped support element comprises a beveled underside for the user's comfort.
